(19) United States
(12) Patent Application Publication
(10) Pub. No.: US 2009/0111942 A1
(43) Pub. Date: Apr. 30, 2009

(54) Method for Making Surface Modified Biomedical Devices

(75) Inventors: Weihong Lang, Amston, CT (US); Yu-Chin Lai, Pittsford, NY (US); Daniel J. Hook, Fairport, NY (US)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 11/924,359

(22) Filed: Oct. 25, 2007

(51) Int. Cl. C08G 63/48

(52) U.S. Cl. 525/74; 525/77; 525/78

(57) ABSTRACT

Disclosed are methods for making a surface modified biomedical device involving (a) exposing a biomedical device having a plurality of biomedical device surface functional groups to one or more ethylenically unsaturated-containing organic compounds having a reactive group that is co-reactive to the biomedical device surface functional groups of the biomedical device; and (b) graft polymerizing a hydrophilic reactive monomer having a complementary reactive functionality with the ethylenically unsaturated functionalities of the ethylenically unsaturated-containing organic compounds on or near the surface of the biomedical device thus forming a biocompatible surface on the biomedical device. The methods disclosed are two-step methods and do not include any additional surface treatment steps.

### BACKGROUND OF THE INVENTION

1. Technical Field

The present invention generally relates to methods of making surface modified biomedical devices such as contact lenses, intraocular lenses, and other ophthalmic devices.

2. Description of the Related Art

Medical devices such as ophthalmic lenses made from, for example, silicone-containing materials, have been investigated for a number of years. Such materials can generally be subdivided into two major classes, namely hydrogels and non-hydrogels. Hydrogels can absorb and retain water in an equilibrium state, whereas non-hydrogels do not absorb appreciable amounts of water. Regardless of their water content, both hydrogel and non-hydrogel silicone medical devices tend to have relatively hydrophobic, non-wettable surfaces that have a high affinity for lipids. This problem is of particular concern with contact lenses.

Those skilled in the art have long recognized the need for modifying the surface of such silicone contact lenses so that they are compatible with the eye. It is known that increased hydrophilicity of the lens surface improves the wettability of the contact lens. This, in turn, is associated with improved wear comfort of contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

Silicone lenses have been subjected to plasma surface treatment to improve their surface properties, e.g., surfaces have been rendered more hydrophilic, deposit resistant, scratch-resistant, or otherwise modified. Examples of previously disclosed plasma surface treatments include subjecting the surface of a contact lens to a plasma containing an inert gas or oxygen (see, for example, U.S. Pat. Nos. 4,055,378; 4,122,942; and 4,214,014); various hydrocarbon monomers (see, for example, U.S. Pat. No. 4,143,949); and combinations of oxidizing agents and hydrocarbons such as water and ethanol (see, for example, WO 95/04609 and U.S. Pat. No. 4,632,844). U.S. Pat. No. 4,312,575 discloses a process for providing a barrier coating on a silicone or polyurethane lens by subjecting the lens to an electrical glow discharge (plasma) process conducted by first subjecting the lens to a hydrocarbon atmosphere followed by subjecting the lens to oxygen during flow discharge, thereby increasing the hydrophilicity of the lens surface.

U.S. Pat. No. 6,582,754 (“the '754 patent”) discloses a process for coating a material surface involving the steps of (a) providing an organic bulk material having functional groups on its surface; (b) covalently binding to the surface of the bulk material a layer of a first compound having a first reactive group and an ethylenically unsaturated double bond by reacting the function groups on the surface of the bulk material with the first reactive group of the first compound; (c) copolymerizing, on the surface of the bulk material, a first hydrophilic monomer and a monomer comprising a second reactive group to form a coating comprising a plurality of primary polymer chains which are covalently bonded to the surface through the first compound, wherein each primary polymer chain comprises second reactive; (d) reacting the second reactive groups of the primary polymer chains with a second compound comprising an ethylenically unsaturated double bond and a third reactive group that is co-reactive with the second reactive group, to covalently bind the second compound to the primary polymer chains; and (e) graft-polymerizing a second hydrophilic monomer to obtain a branched hydrophilic coating on the surface of the bulk material, wherein the branched hydrophilic coating comprises the plurality of the primary polymer chains and a plurality of secondary chains each of which is covalently attached through the second compound to one of the primary chains. The process disclosed in the '754 patent is time consuming as it involves multiple steps and uses many reagents in producing the coating on the substrate.

Accordingly, it would be desirable to provide improved methods for surface treating a biomedical device such as a hydrogel contact lens to provide a biomedical device with an optically clear, hydrophilic surface film that will not only exhibit improved wettability, but which may generally allow the use of a hydrogel contact lens in the human eye for an extended period of time.

### SUMMARY OF THE INVENTION

In accordance with one embodiment of the present invention, a method for making a surface modified biomedical device is provided, the method comprising: (a) exposing a biomedical device having a plurality of biomedical device surface functional groups to one or more ethylenically unsaturated-containing organic compounds having a reactive group that is co-reactive to the biomedical device surface functional groups of the biomedical device; and (b) graft polymerizing a hydrophilic reactive monomer having a complementary reactive functionality with the ethylenically unsaturated functionalities of the ethylenically unsaturated-containing organic compounds on or near the surface of the biomedical device thus forming a biocompatible surface on the biomedical device in the absence of any additional surface treatment steps.

In accordance with a second embodiment of the present invention, a method for making a surface modified biomedical device is provided, the method consisting essentially of: (a) exposing a biomedical device having a plurality of biomedical device surface functional groups to one or more ethylenically unsaturated-containing organic compounds having a reactive group that is co-reactive to the surface functional groups of the biomedical device; and (b) graft polymerizing a hydrophilic reactive monomer having a complementary reactive functionality with the ethylenically unsaturated functionalities of the ethylenically unsaturated-containing organic compounds on or near the surface of the biomedical device thus forming a biocompatible surface on the biomedical device.

The methods of the present invention advantageously provide a surface modified biomedical device in two steps. In this manner, a biomedical device with an optically clear, hydrophilic surface can be obtained in a simple and cost efficient manner.

### DESCRIPTION OF THE PREFERRED EMBODIMENTS

The present invention is directed to a two step surface treatment method of biomedical devices. As used herein, a “biomedical device” is any article that is designed to be used while either in or on mammalian tissues or fluid, and preferably in or on human tissue or fluids. Representative examples of biomedical devices include, but are not limited to, artificial ureters, diaphragms, intrauterine devices, heart valves, catheters, denture liners, prosthetic devices, ophthalmic lens applications, where the lens is intended for direct placement in or on the eye, such as, for example, intraocular devices and contact lenses. The preferred biomedical devices are ophthalmic devices, particularly contact lenses, and most particularly contact lenses made from silicone hydrogels.

As used herein, the term “ophthalmic device” refers to devices that reside in or on the eye. These devices can provide optical correction, wound care, drug delivery, diagnostic functionality or cosmetic enhancement or effect or a combination of these properties. Useful ophthalmic devices include, but are not limited to, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

In one embodiment, biomedical devices for use in the method of the present invention include devices which are formed from material not hydrophilic per se. Such devices are formed from materials known in the art and include, by way of example, polysiloxanes, perfluoropolyethers, fluorinated poly(meth)acrylates or equivalent fluorinated polymers derived, e.g., from other polymerizable carboxylic acids, polyalkyl (meth)acrylates or equivalent alkylester polymers derived from other polymerizable carboxylic acids, or fluorinated polyolefins, such as fluorinated ethylene propylene polymers, or tetrafluoroethylene, preferably in combination with a dioxol, e.g., perfluoro-2,2-dimethyl-1,3-dioxol. Representative examples of suitable bulk materials include, but are not limited to, Lotrafilcon A, Neofocon, Pasifocon, Telefocon, Silafocon, Fluorsilfocon, Paflufocon, Silafocon, Elastofilcon, Fluorofocon or Teflon AF materials, such as Teflon AF 1600 or Teflon AF 2400 which are copolymers of about 63 to about 73 mol % of perfluoro-2,2-dimethyl-1,3-dioxol and about 37 to about 27 mol % of tetrafluoroethylene, or of about 80 to about 90 mol % of perfluoro-2,2-dimethyl-1,3-dioxol and about 20 to about 10 mol % of tetrafluoroethylene.

In another embodiment, biomedical devices for use in the method of the present invention include devices which are formed from material hydrophilic per se, since reactive groups, e.g., carboxy, carbamoyl, sulfate, sulfonate, phosphate, amine, ammonium or hydroxy groups, are inherently present in the material and therefore also at the surface of a biomedical device manufactured therefrom. Such devices are formed from materials known in the art and include, by way of example, polyhydroxyethyl acrylate, polyhydroxyethyl methacrylate (HEMA), polyvinyl pyrrolidone (PVP), polyacrylic acid, polymethacrylic acid, polyacrylamide, polydimethylacrylamide (DMA), polyvinyl alcohol and the like and copolymers thereof, e.g., from two or more monomers selected from hydroxyethyl acrylate, hydroxyethyl methacrylate, N-vinyl pyrrolidone, acrylic acid, methacrylic acid, acrylamide, dimethyl acrylamide, vinyl alcohol and the like. Representative examples of suitable bulk materials include, but are not limited to, Polymacon, Tefilcon, Methafilcon, Deltafilcon, Bufilcon, Phemfilcon, Ocufilcon, Focofilcon, Etafilcon, Hefilcon, Vifilcon, Tetrafilcon, Perfilcon, Droxifilcon, Dimefilcon, Isofilcon, Mafilcon, Nelfilcon, Atlafilcon and the like.

In another embodiment, biomedical devices for use in the method of the present invention include devices which are formed from material which are amphiphilic segmented copolymers containing at least one hydrophobic segment and at least one hydrophilic segment which are linked through a bond or a bridge member.

As one skilled in the art will readily appreciate, the biomedical device surface functional groups of the biomedical device for use in the methods of the present invention may be inherently present at the surface of the device. However, if the biomedical device contains too few or no functional groups, the surface of the device can be modified by known techniques, for example, plasma chemical methods or conventional functionalization with groups such as —OH, —NH₂ or —CO₂H. For example, the surface of the biomedical device can be treated with a plasma discharge or corona discharge to introduce or increase the population of biomedical device surface functional groups. The type of gas introduced into the treatment chamber will depend on the desired type of biomedical device surface functional group. For example, hydroxyl surface groups can be produced with a treatment chamber atmosphere containing water vapor or alcohols. Carboxyl surface groups can be produced with a treatment chamber atmosphere containing oxygen, air or another oxygen-containing gas. Amino surface groups can be produced with a treatment chamber atmosphere containing ammonia or an amine source. Mercaptan surface groups can be produced with a treatment chamber atmosphere containing sulfur-containing gases such as organic mercaptans or hydrogen sulfide. As one skilled in the art will readily appreciate, a combination of any of the foregoing gases can be used in the treatment chamber to produce a combination of biomedical device surface functional groups on the surface of the biomedical device. Methods and apparatus for surface treatment by plasma discharge are disclosed in, for example, U.S. Pat. Nos. 6,550,915 and 6,794,456, the contents of which are incorporated by reference herein.

Suitable biomedical device surface functional groups of the biomedical device include a wide variety of groups well known to the skilled artisan. Representative examples of such functional groups include, but are not limited to, hydroxy groups, amino groups, carboxy groups, carbonyl groups, aldehyde groups, sulfonic acid groups, sulfonyl chloride groups, isocyanato groups, carboxy anhydride groups, lactone groups, azlactone groups, epoxy groups and groups being replaceable by amino or hydroxy groups, such as halo groups, or mixtures thereof. In one embodiment, the biomedical device surface functional groups of the biomedical device are amino groups and/or hydroxy groups.

In step (a) of the method of the present invention, the reactive groups of the one or more ethylenically unsaturated-containing organic compounds are covalently bound to the surface of the biomedical device via reaction with the biomedical device surface functional groups of the biomedical device by techniques known in the art. For example, the biomedical device can be contacted with a solution containing the ethylenically unsaturated-containing organic compounds for a time period sufficient for the reactive groups of the one or more ethylenically unsaturated-containing organic compounds to be covalently bound to the biomedical device surface functional groups of the biomedical device.

Useful ethylenically unsaturated-containing organic compounds having reactive groups include, for example, an ethylenically unsaturated compound having from 2 to about 18 carbon atoms which is substituted by a reactive group that is co-reactive to the biomedical device surface functional groups of the biomedical device. Representative examples of such reactive groups include, but are not limited to, carboxy groups, carboxylic acid ester groups, carboxylic acid anhydride groups, halo groups, epoxy groups, lactone groups, azlactone groups and/or isocyanato groups.

In one embodiment, suitable ethylenically unsaturated-containing organic compounds having such reactive groups and an ethylenically unsaturated double bond can be represented by the general formulae:

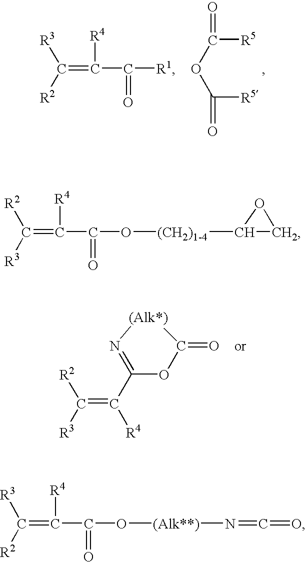

wherein R¹ is halogen, hydroxy, unsubstituted or hydroxy-substituted C₁-C₆ alkoxy or phenoxy, R² and R³ are each independently hydrogen or C₁-C₁₈ alkyl, R⁴ is hydrogen or C₁-C₁₈ alkyl, R⁵ and R⁵′ are each an ethylenically unsaturated-containing radical, or R⁵ and R⁵′ together form a bivalent radical —C(R²)=C(R⁴)— wherein R² and R⁴ are as defined above, and (Alk*) is C₁-C₆ alkylene, and (Alk**) is C₂-C₁₂ alkylene.

Representative examples of halogen groups include, by way of example, fluorine, chlorine, bromine, iodine and the like.

Representative examples of alkyl groups for use herein include, by way of example, a straight or branched alkyl chain radical containing carbon and hydrogen atoms of from 1 to about 18 carbon atoms and preferably from 1 to about 4 carbon atoms, e.g., methyl, ethyl, n-propyl, 1-methylethyl (isopropyl), n-butyl, n-pentyl, etc., and the like.

An ethylenically unsaturated-containing radical can be represented by the general formula:

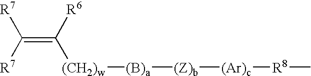

wherein R⁶ is hydrogen or methyl;
each R⁷ is independently hydrogen, an alkyl radical having 1 to 6 carbon atoms, or a —CO—Y— R⁹ radical wherein Y is —O—, —S— or —NH— and R⁹ is an alkyl radical having 1 to about 10 carbon atoms;
R⁸ is a divalent alkenyl radical having 1 to about 12 carbon atoms;
B denotes —O— or —NH—; Z denotes —CO—, —OCO— or —COO;
Ar denotes an aromatic radical having 6 to about 30 carbon atoms;
w is 0 to 6; a is 0 or 1; b is 0 or 1; and c is 0 or 1.

In a preferred embodiment, the ethylenically unsaturated-containing organic compounds having such reactive groups include 2-isocyanatoethyl methacrylate (IEM), 2-vinyl-azlactone, 2-vinyl-4,4-dimethyl-azlactone, (meth)acrylic acid or a derivative thereof, e.g., (meth)acryloyl chloride or (meth)acrylic acid anhydride, maleic acid anhydride, 2-hydroxyethyl acrylate (HEA), 2-hydroxy methacrylate (HEMA), glycidyl acrylate or glycidyl methacrylate.

In step (b) of the method of the present invention, a hydrophilic reactive monomer having a complementary reactive functionality with the ethylenically unsaturated functionalities of the ethylenically unsaturated-containing organic compounds is grafted onto the ethylenically unsaturated-containing organic compounds thus forming a biocompatible surface on the biomedical device. Suitable hydrophilic reactive monomers include, but are not limited to, ethylenically unsaturated terminated hydrophilic monomers such as a hydroxyalkyl(meth)acrylate or acrylamide such as hydroxyalkyl(meth)acrylates containing from 1 to 4 carbon atoms in the hydroxyalkyl moiety, e.g., a 2-hydroxyethyl(meth)acrylate; a vinyl monomer such as an N-vinyl lactam containing from 5 to 7 atoms in the lactam ring, e.g., a vinyl pyrrolidone such as N-vinyl pyrrolidone and the like; a polyhydroxyl(meth)acrylate having 2 to 10 hydroxyl groups and preferably 2 to 6 hydroxyl groups and the alkyl group contains from 1 to 6 carbon atoms, e.g., glycerol -acrylates, -methacrylates, -ethacrylates, -acrylamides, -methacrylamides, -ethacrylamides, and the like, (meth)acrylic acid and the like, N-vinyl-N-alkyl amides such as N-vinyl-N-methyl acetamide and the like and mixtures thereof. In another embodiment, ethylenically capped macromers or prepolymers of the hydrophilic monomers such as a (meth)acrylated capped polymer or copolymer of N-vinylpyrrolidone, N,N,-dimethylacrylamide and the like can also be used.

The hydrophilic reactive monomer(s) may be applied to the modified surface of the biomedical device and polymerized there according to methods known per se. For example, the surface modified biomedical device can first be immersed in a solution of the hydrophilic reactive monomer, or the hydrophilic reactive monomer is first deposited on the surface modified biomedical device, for example, by dipping, spraying, spreading, knife coating, pouring, rolling, spin coating or vacuum vapor deposition. Suitable solvents, if used in the polymerization method, include water, cyclic ethers such as tetrahydrofuran (THF) and the like, nitriles such as acrylonitrile and the like and mixture thereof.

Polymerization of the hydrophilic reactive monomer(s) on the material surface can then be initiated by free radical polymerization by exposing the biomedical device to heat and/or radiation, e.g., ultraviolet light (UV), visible light, or high energy radiation, to produce a surface modified biomedical device according to conventional methods. A polymerization initiator may be included in the solution containing the hydrophilic reactive monomer to facilitate the polymerization step. Representative free radical thermal polymerization initiators include organic peroxides such as, for example, acetal peroxide, lauroyl peroxide, decanoyl peroxide, stearoyl peroxide, benzoyl peroxide, tertiarylbutyl peroxypivalate, peroxydicarbonate, and the like and mixtures thereof. Representative UV initiators are those known in the field such as, for example, benzoin methyl ether, benzoin ethyl ether, Darocure 1173, 1164, 2273, 1116, 2959, 3331 (EM Industries) and Igracure 651 and 184 (Ciba-Geigy), and the like and mixtures thereof. Generally, the initiator will be employed in the monomeric mixture at a concentration at about 0.1 to about 5 percent by weight of the total mixture.

In the case of thermal initiated polymerization of the hydrophilic reactive monomer(s), polymerization can be carried out at an elevated temperature, e.g., at a temperature of from about 35° C. to about 150° C. and preferably about 40° C. to about 125° C., for a time period of, for example, from about 10 minutes to about 48 hours in the absence or presence of a solvent. The reaction is advantageously conducted in a subsurface gas purge such as nitrogen.

In the case of irradiation, polymerization of the reactive groups of the hydrophilic reactive monomer(s) to the ethylenically unsaturated functionalities of the ethylenically unsaturated-containing organic compounds can be carried in one or more steps. The time period for polymerization can vary widely, e.g., in the range of up to about 30 minutes. It is advantageous to carry out the irradiation in a subsurface gas purge such as nitrogen.

In one embodiment, an illustration of the method of the present invention is generally depicted below in Scheme I.

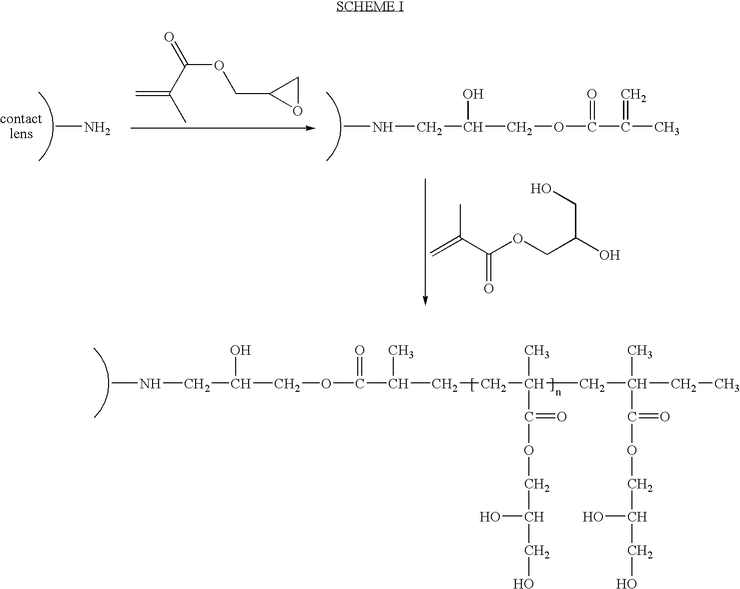

wherein n is at least 1 and ordinarily from 1 to about 50.

After polymerization is completed, any non-covalently bonded monomers, oligomers or polymers formed can be removed, for example, by treatment with a suitable solvent. The resulting surface modified biomedical device can then be used “as is”. In other words, no additional surface treatments steps will have to be carried out to modify the resulting surface modified biomedical device. As used herein, the phrase “without any additional surface treatment steps” shall be understood to mean that the exterior surface of the surface modified biomedical device of the present invention is not further treated to modify the surface thereof by, for example, oxidation treatments, plasma treatments, grafting treatments, coating treatments and the like. However, it shall be understood that coatings such as color or other cosmetic enhancement may be applied to devices of the present invention.

The following examples are provided to enable one skilled in the art to practice the invention and are merely illustrative of the invention. The examples should not be read as limiting the scope of the invention as defined in the claims.

### EXAMPLE 1

Step I: Bausch & Lomb PureVision® lenses, after being cast and solvent removed, were plasma-treated in a capacitively coupled plasma chamber using a 13.56 MHz RF source under the following conditions.

Ammonia gas 200 Watts RF, 0.3 torr chamber pressure, 1 min RF exposure

Butadiene gas 400 Watts RF, 0.2 torr chamber pressure, 1 min RF exposure

Ammonia gas 200 Watts RF, 0.3 torr chamber pressure, 1 min RF exposure

The plasma treated lenses were then dipped in a solution of tetrahydrofuran (THF) containing 5% acryloyl chloride overnight. The resulting lenses were hydrated in deionized (DI) water and then saved in DI water.

Step II: The hydrated lenses of step I were autoclaved in DI water containing 10 weight % N-vinyl pyrrolidone (NVP) and 1 weight % azo bis-isobutylnitrile (AIBN) for 30 minutes at 121° C. After the autoclave was completed, the surface modified lenses were stored in a borated buffer solution (BBS).

### XPS Analysis

The lenses obtained after steps I and II of Example 1 were analyzed for their atomic concentration by X-ray Photoelectron Spectrometer (XPS). The XPS utilized in this study was a Physical Electronics [PHI] Quantum 2000 Scanning X-Ray Microprobe X-ray Photoelectron Spectrometer. This instrument utilizes a monochromatic Al anode operated at 18 kV and 100 Watts. All acquisitions were collected over a 1400 micron×100 micron analysis area. Dual beam neutralization (ions and electrons) was used during all analysis. The base pressure of the instrument was 5×10⁻¹⁰ torr and during operation the pressure was less than or equal to 1×10⁻⁷ torr. This instrument made use of a hemispherical analyzer operated in FAT mode. A gauze lens was coupled to a hemispherical analyzer in order to increase signal throughput. Assuming the inelastic mean free path for a carbon 1 s photoelectron is 35 Å, the practical measure for sampling depth for this instrument at a sampling angle of 45° is approximately 75 Å.

Each of the specimens was analyzed utilizing a low resolution survey spectra [0-1100 eV] to identify the elements present on the sample surface. The high resolution spectra were performed on those elements detected from the low resolution scans. The elemental composition was determined from the high resolution spectra. The atomic composition was calculated from the areas under the photoelectron peaks after sensitizing those areas with the instrumental transmission function and atomic cross sections for the orbital of interest. Since XPS does not detect the presence of hydrogen or helium, these elements will not be included in any calculation of atomic percentages. It is also noted that atomic percentages may vary if a different instrument design, i.e., transmission function, is utilized, so that for purposes of exact reproducibility the atomic percentage numbers in the application refer to the specified instrument design, as will be understood by the skilled artisan.

The data reflects the atomic composition over the top 75 Å. (relative to carbon 1 s electrons).

### Contact Angle Measurement

The contact angles of the surface of the lenses obtained after steps I and II of Example 1 were also measured. The contact angle was measured using a VCA 2500 XE Video Contact Angle System from AST Products. The system utilized a digitally controlled 100 μl syringe to form and dispense a 0.6 μl water droplet onto the sample surface. A digital image of the water droplet coupled to the sample surface was captured using a PC based Imaging Technology Inc. frame grabber board running on Windows XP. The water used for all contact angle analysis was HPLC grade purity obtained from Fisher Scientific. The surface tension of the water used was measured to be 72 (±1) dynes/cm.

The XPS results and contact angles for the lenses obtained after steps I and II of Example 1 are set forth below in Table 1.

TABLE 1

| | Contact | | | |
|---|---|---|---|---|
| | Angle | | | |
| | (degrees) | C1s | N1s | O1s |
| Step I | 80.9(5.5) | 67.7(2.5) | 3.4(0.7) | 19.3(1.0) |
| Step II | 53.5(5.1) | 67.2(4.5) | 6.3(0.4) | 19.5(2.3) |

As the data show, there was a sharp increase in surface nitrogen content and a decrease in the contact angles, i.e., from 80.9 degrees to around 53.5 degrees indicating a relatively large increase in the surface wettability after the surface of the treated lens was graft polymerized with a hydrophilic monomer (i.e., NVP).

### EXAMPLE 2

Step I: Bausch & Lomb PureVision® lenses, after being cast and solvent removed, were plasma-treated in substantially the same manner as in Example 1. The plasma-treated lenses were then dipped in a solution of THF containing 5% acryloyl chloride overnight. The resulting lenses were hydrated in DI water and then saved in DI water.

Step II: The hydrated lenses of step I were autoclaved in DI water containing 10 weight % glycerol methacrylate and 0.2 weight % AIBN for 30 minutes at 121° C. After the autoclave was completed, the surface modified lenses were stored in a BBS. The lenses obtained after steps I and II were analyzed for their atomic concentration by XPS and their contact angles were measured as described above. The XPS results and contact angles for the lenses are set forth below in Table 2.

TABLE 2

| | Contact | | | |
|---|---|---|---|---|
| | Angle | | | |
| | (degrees) | C1s | N1s | O1s |
| Step I | 80.9(5.5) | 67.7(2.5) | 3.4(0.7) | 19.3(1.0) |
| Step II | 61.0(8.6) | 64.9(1.6) | 2.9(0.3) | 25.2(0.6) |

As the data show, the contact angles of surface of the lens after steps I and II significantly decreased, i.e., from 80.9 degrees to around 61 degrees, indicating a relatively large increase in surface wettability. The surface nitrogen atom content decreased because it was coated with a non-nitrogen-containing glycerol methacrylate copolymer.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for making a surface modified biomedical device, the method comprising: (a) exposing a biomedical device having a plurality of biomedical device surface functional groups to one or more ethylenically unsaturated-containing organic compounds having a reactive group that is co-reactive to the biomedical device surface functional groups of the biomedical device; and (b) graft polymerizing a hydrophilic reactive monomer having a complementary reactive functionality with the ethylenically unsaturated functionalities of the ethylenically unsaturated-containing organic compounds on or near the surface of the biomedical device thus forming a biocompatible surface on the biomedical device in the absence of any additional surface treatment steps.

2. The method of claim 1, wherein the biomedical device surface functional group of the biomedical device is selected from the group consisting of a hydroxy group, amino group, carboxy group, carbonyl group, aldehyde group, sulfonic acid group, sulfonyl chloride group, isocyanato group, carboxy anhydride group, lactone group, azlactone group, epoxy group and mixtures thereof.

3. The method of claim 1, wherein the biomedical device surface functional group of the biomedical device is selected from the group consisting of a hydroxy group, amino group, carboxy group and mixtures thereof and the reactive group of the ethylenically unsaturated-containing organic compound is selected from the group consisting of an isocyanato group, azlactone group, epoxy group, halo group, carboxy anhydride group, carboxy group and hydroxy group.

4. The method of claim 1, wherein the ethylenically unsaturated-containing organic compound contains 2 to about 18 carbon atoms which is substituted by a reactive group selected from the group consisting of an isocyanato group, azlactone group, epoxy group, halo group, carboxy anhydride group, carboxy group and hydroxy group.

5. The method of claim 1, wherein the one or more ethylenically unsaturated-containing organic compound is selected from the group of 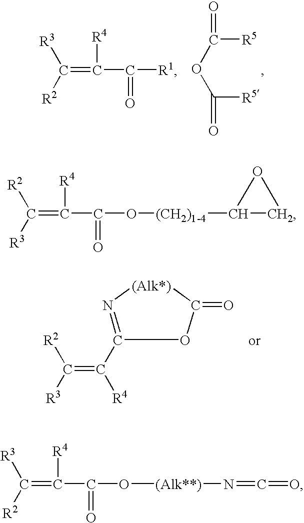
wherein R¹ is halogen, hydroxy, unsubstituted or hydroxy-substituted C₁-C₆ alkoxy or phenoxy, R² and R³ are each independently hydrogen or C₁-C₄ alkyl, R⁴ is hydrogen or C₁-C₄ alkyl, R⁵ and R⁵′ are each an ethylenically unsaturated-containing radical having from 2 to 6 carbon atoms, or R⁵ and R⁵ together form a bivalent radical —C(R²)═C(R⁴)— wherein R¹⁴ and R¹⁶ are as defined above, and (Alk*) is C₁-C₆ alkylene, and (Alk**) is a C₂-C₁₂ alkylene.

6. The method of claim 1, wherein the one or more ethylenically unsaturated-containing organic compound is selected from the group of 2-isocyanatoethylmethacrylate (IEM), 2-vinyl-azlactone, 2-vinyl-4,4-dimethyl-azlactone, (meth)acrylic acid, (meth)acryloyl chloride, (meth)acrylic acid anhydride, maleic acid anhydride, 2-hydroxyethylacrylate (HEA), 2-hydroxy methacrylate (HEMA), glycidyl acrylate, glycidyl methacrylate and mixtures thereof.

7. The method of claim 1, wherein the exposing step (a) includes contacting the biomedical device with a solution containing the one or more ethylenically unsaturated-containing organic compounds.

8. The method of claim 1, wherein the hydrophilic reactive monomer is selected from the group consisting of an acrylamide, lactam, poly(alkyleneoxy)(meth)acrylate, (meth)acrylic acid, hydroxyl-containing-(meth)acrylate, N-vinyl-N-alkyl amide and mixtures thereof.

9. The method of claim 1, wherein the hydrophilic reactive monomer is selected from the group consisting of dimethylacrylamide, acacetamirylamide, glyceryl methacrylate, (meth)acrylic acid, N-vinyl pyrrolidone, N-vinyl-N-methylacetamide and mixtures thereof.

10. The method of claim 1, wherein the grafting step (b) includes radical polymerization or ionic polymerization.

11. The method of claim 10, wherein the grafting step (b) includes contacting the biomedical device with a solution containing the one or more of the hydrophilic reactive monomers prior to grafting the hydrophilic reactive monomers to the ethylenically unsaturated-containing organic compounds.

12. The method of claim 1, wherein the biomedical device is an ophthalmic lens.

13. The method of claim 12, wherein the ophthalmic lens is a contact lens or an intraocular lens.

14. A method for making a surface modified biomedical device, the method consisting essentially of: (a) exposing a biomedical device having a plurality of biomedical device surface functional groups to one or more ethylenically unsaturated-containing organic compounds having a reactive group that is co-reactive to the biomedical device surface functional groups of the biomedical device; and (b) graft polymerizing a hydrophilic reactive monomer having a complementary reactive functionality with the ethylenically unsaturated functionalities of the ethylenically unsaturated-containing organic compounds on or near the surface of the biomedical device thus forming a biocompatible surface on the biomedical device.

15. The method of claim 14, wherein the biomedical device surface functional group of the biomedical device is selected from the group consisting of a hydroxy group, amino group, carboxy group, carbonyl group, aldehyde group, sulfonic acid group, sulfonyl chloride group, isocyanato group, carboxy anhydride group, lactone group, azlactone group, epoxy group and mixtures thereof.

16. The method of claim 14, wherein the biomedical device surface functional group of the biomedical device is selected from the group consisting of a hydroxy group, amino group, carboxy group and mixtures thereof and the reactive group of the ethylenically unsaturated-containing organic compound is selected from the group consisting of an isocyanato group, azlactone group, epoxy group, halo group, carboxy anhydride group, carboxy group and hydroxy group.

17. The method of claim 14, wherein the ethylenically unsaturated-containing organic compound contains 2 to about 18 carbon atoms which is substituted by a reactive group selected from the group consisting of an isocyanato group, azlactone group, epoxy group, halo group, carboxy anhydride group, carboxy group and hydroxy group.

18. The method of claim 14, wherein the one or more ethylenically unsaturated-containing organic compound is selected from the group of 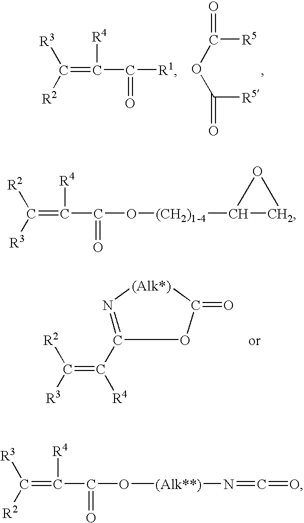
wherein R¹ is halogen, hydroxy, unsubstituted or hydroxy-substituted C₁-C₆ alkoxy or phenoxy, R² and R³ are each independently hydrogen or C₁-C₄ alkyl, R⁴ is hydrogen or C₁-C₄ alkyl, R⁵ and R⁵ are each an ethylenically unsaturated-containing radical having from 2 to 6 carbon atoms, or R⁵ and R⁵═ together form a bivalent radical —C(R²)=C(R⁴)- wherein R¹⁴ and R¹⁶ are as defined above, and (Alk*) is C₁-C₆ alkylene, and (Alk**) is a C₂-C₁₂ alkylene.

19. The method of claim 14, wherein the one or more ethylenically unsaturated-containing organic compound is selected from the group of IEM, 2-vinyl-azlactone, 2-vinyl-4,4-dimethyl-azlactone, (meth)acrylic acid, (meth)acryloyl chloride, (meth)acrylic acid anhydride, maleic acid anhydride, HEA, HEMA, glycidyl acrylate, glycidyl methacrylate and mixtures thereof.

20. The method of claim 14, wherein the exposing step (a) includes contacting the biomedical device with a solution containing the one or more ethylenically unsaturated-containing organic compounds.

21. The method of claim 14, wherein the hydrophilic reactive monomer is selected from the group consisting of an acrylamide, lactam, poly(alkyleneoxy)(meth)acrylate, (meth)acrylic acid, hydroxyl-containing-(meth)acrylate, N-vinyl-N-alkyl amide and mixtures thereof.

22. The method of claim 14, wherein the hydrophilic reactive monomer is selected from the group consisting of dimethylacrylamide, acrylamide, glyceryl methacrylate, (meth)acrylic acid, N-vinyl pyrrolidone, N-vinyl-N-methylacetamide and mixtures thereof.

23. The method of claim 14, wherein the grafting step (b) includes radical polymerization or ionic polymerization.

24. The method of claim 23, wherein the grafting step (b) includes contacting the biomedical device with a solution containing the one or more of the hydrophilic reactive monomers prior to grafting the hydrophilic reactive monomers to the ethylenically unsaturated-containing organic compounds.

25. The method of claim 14, wherein the biomedical device is a contact lens or an intraocular lens.
